(19) United States
(12) Patent Application Publication
(10) Pub. No.: US 2023/0085326 A1
(43) Pub. Date: Mar. 16, 2023

(54) RFID MODULE, AND PNEUMATIC TIRE WITH THE SAME EMBEDDED THEREIN

(71) Applicant: The Yokohama Rubber Co., LTD., Tokyo (JP)

(72) Inventors: Masahiro NARUSE, Kanagawa (JP); Yuki NAGAHASHI, Kanagawa (JP)

(21) Appl. No.: 17/904,163

(22) PCT Filed: Feb. 12, 2021
(86) PCT No.: PCT/JP2021/005212

§ 371 Date: Aug. 12, 2022

(30) Foreign Application Priority Data
Feb. 17, 2020 (JP) 2020-024645

(51) Int. Cl. B60C 1/00

(52) U.S. Cl. CPC B60C 1/0041; B60C 2001/005; B60C 2001/0075

(57) ABSTRACT

Provided are an RFID (radio frequency identification) module and a pneumatic tire in which the RFID module is embedded. An RFID module includes an IC (integrated circuit) substrate that stores data, an antenna that transmits and receives data, and a covering layer that covers the antenna. The covering layer contains calcium carbonate, and a relative dielectric constant of the covering layer is 7 or less.

### TECHNICAL FIELD

The present technology relates to an RFID (radio frequency identification) module and a pneumatic tire in which the RFID module is embedded, and particularly relates to an RFID module and a pneumatic tire in which the RFID module is embedded that allow improved durability and communication performance of the RFID module while keeping a shape of a covering layer.

### BACKGROUND ART

In a pneumatic tire, an RFID tag is embedded (see, for example, Japan Unexamined Patent Publication No. H07-137510). Providing an insulating layer that insulates a rubber member around the RFID module is suitable for extending the communication distance of the RFID module. In such an insulating layer, silica is commonly blended to strengthen the insulation layer. However, blending silica with the insulating layer may cause the insulating layer to shrink in forming the insulating layer and fail to keep the desired shape, leading to degradation in the durability.

### SUMMARY

The present technology provides a pneumatic tire that can provide an RFID module and a pneumatic tire that allow improved durability and communication performance of the RFID module while keeping the shape of a covering layer.

An RFID module according to an embodiment of the present technology to achieve the object described above includes an IC (integrated circuit) substrate that stores data, an antenna that transmits and receives the data, and a covering layer that covers the antenna. The covering layer contains calcium carbonate, and the relative dielectric constant of the covering layer is 7 or less.

A pneumatic tire according to an embodiment of the present technology includes a tread portion extending in a tire circumferential direction and having an annular shape, a pair of sidewall portions disposed on both sides of the tread portion, a pair of bead portions disposed on inner sides in a tire radial direction of the pair of sidewall portions, and a carcass layer mounted between the pair of bead portions. In the pneumatic tire, the RFID module is embedded.

In the RFID module according to an embodiment of the present technology, the covering layer contains calcium carbonate. This suppresses shrinkage in forming the covering layer compared to a covering layer containing silica, the shape of the RFID module can be kept, and the calcium carbonate as a filler contributes to lowering the relative dielectric constant of the covering layer, improving the communication performance of the RFID module. Furthermore, the relative dielectric constant of the covering layer is 7 or less. This can improve the radio wave transmitting property of the RFID module and obtain the effect of suppressing attenuation of radio wave intensity, further improving the communication performance of the RFID module.

In the RFID module according to an embodiment of the present technology, the covering layer is preferably formed of rubber or elastomer and 20 phr or more of calcium carbonate. This can relatively lower the relative dielectric constant of the covering layer, compared to a covering layer containing carbon, and can effectively improve the communication performance of the RFID module.

The covering layer preferably contains from 20 phr to 55 phr of calcium carbonate. This can relatively lower the relative dielectric constant of the covering layer and effectively improve the communication performance of the RFID module.

The thickness of the covering layer preferably ranges from 0.5 mm to 3.0 mm. This can effectively improve the communication performance of the RFID module while ensuring the protective effect of the covering layer.

Preferably, the covering layer has a dielectric loss tangent of 0.1 or less, a surface resistivity of 10¹² Ωm or more, and a volume resistivity of 10¹² Ωm or more. The dielectric loss tangent can be set to the range described above to prevent attenuation of radio wave intensity in the RFID module during radio wave transmission, and the electrical resistances can be set to the ranges described above to effectively improve the communication performance of the RFID module.

The storage modulus E′c (20° C.) at 20° C. of the covering layer preferably ranges from 2 MPa to 12 MPa. This can improve the protective effect of the covering layer on the RFID module and effectively improve the durability of the RFID module.

The glass transition temperature of the covering layer preferably ranges from −70° C. to −45° C. This allows the use of the RFID module in a high or low temperature environment without impairing the durability of the RFID module.

In the pneumatic tire according to an embodiment of the present technology, the relative dielectric constant of the covering layer is preferably lower than that of a rubber member adjacent to the covering layer. This can sufficiently ensure the radio wave transmitting property of the RFID module.

Preferably, the RFID module is disposed on an outer side in a tire width direction of the carcass layer, and the storage modulus E′c (20° C.) at 20° C. of the covering layer and the storage modulus E′out (20° C.) at 20° C. of a rubber member having the largest storage modulus at 20° C. of rubber members located on an outer side in the tire width direction of the RFID module satisfy the relationship 0.1≤E′c (20° C.)/E′out (20° C.)≤1.5. This can effectively improve the durability of the RFID module.

The center of the RFID module is preferably disposed 10 mm or more spaced in the tire circumferential direction from a splice portion of a tire component. This can effectively improve the tire durability.

The RFID module is preferably disposed between a position 15 mm on an outer side in the tire radial direction of an upper end of a bead core of the bead portion and a tire maximum width position. The RFID module thus disposed in a region where the stress amplitude during traveling is small can effectively improve in the durability of the RFID module, and further, does not decrease in the durability of the tire.

The distance between the cross-sectional center of the RFID module and a tire surface is preferably 1 mm or more. This can effectively improve the tire durability and can improve the tire scratch resistance.

The antenna preferably has a helical shape. This allows the antenna to follow the deformation of the tire during traveling, improving the durability of the RFID module.

In the present technology, the storage modulus E′ is measured in accordance with JIS (Japanese Industrial Standard)-K6394 under specified temperatures, a frequency of 10 Hz, an initial strain of 10%, a dynamic strain of ±2% in a tensile deformation mode, using a viscoelastic spectrometer. The surface resistivity [Ωm] and volume resistivity [Ωm] of the covering layer are measured in accordance with JIS-K6271.

### BRIEF DESCRIPTION OF DRAWINGS

FIGS. 1A and 1B illustrate an example of an RFID module according to an embodiment of the present technology, FIG. 1A is a perspective view, and FIG. 1B is a cross-sectional view.

FIG. 2 is a meridian cross-sectional view illustrating a pneumatic tire in which an RFID module is embedded according to an embodiment of the present technology.

FIG. 3 is a meridian cross-sectional view schematically illustrating the pneumatic tire of FIG. 2.

FIG. 4 is an equator line cross-sectional view schematically illustrating the pneumatic tire of FIG. 2.

FIG. 5 is an enlarged cross-sectional view illustrating an RFID module embedded in the pneumatic tire of FIG. 2.

FIGS. 6A and 6B illustrate a modified example of an RFID module according to an embodiment of the present technology, FIG. 6A is a perspective view, and FIG. 6B is a cross-sectional view.

### DETAILED DESCRIPTION

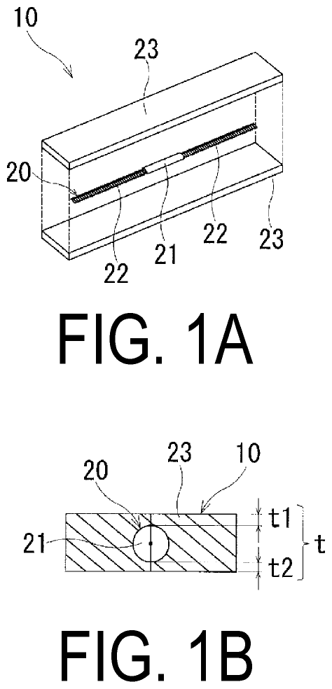

Configurations of embodiments of the present technology will be described in detail below with reference to the accompanying drawings. FIGS. 1A and 1B illustrate an RFID module according to an embodiment of the present technology.

As illustrated in FIGS. 1A and 1B, an RFID module 10 according to the present embodiment includes a transponder 20 and a covering layer 23 covering the transponder 20. As the transponder 20, for example, a radio frequency identification (RFID) tag may be used. The transponder 20 includes an IC substrate 21 for storing data and an antenna 22 for transmitting and receiving data in a non-contact manner. The use of the transponder 20 as described above allows for writing or reading data as appropriate and efficiently managing the data. Note that the RFID is an automatic recognition technology that includes a reader/writer having an antenna and a controller and an ID (identification) tag having an IC (integrated circuit) substrate and an antenna and allows for wirelessly communicating data.

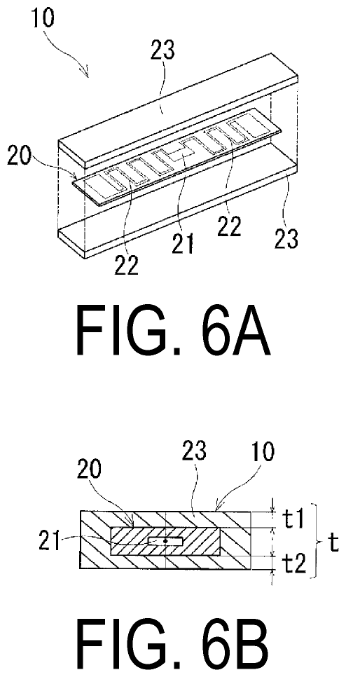

In FIG. 1A, the antenna 22 of the transponder 20 projects from each of two end portions of the IC substrate 21 and has a helical shape. The length of the antenna 22 may be changed as appropriate to ensure communication performance. Note that the overall shape of the transponder 20 is not particularly limited and can be columnar as illustrated in FIGS. 1A and 1B or plate-like as illustrated in FIGS. 6A and 6B.

The covering layer 23 covers all of the transponder 20, covering both front and back surfaces of the transponder 20. The covering layer 23 contains calcium carbonate as a non-reinforcing filler. Here, the covering layer 23 preferably does not contain a non-reinforcing filler other than calcium carbonate. The calcium carbonate contained in the covering layer 23 is not particularly limited, but can be, for example, heavy calcium carbonate or a calcium carbonate surface treated with a surface treating agent. Such calcium carbonate contributes to a reduction in the relative dielectric constant of the covering layer 23 due to a lower relative dielectric constant than other inorganic fillers. Examples of the non-reinforcing fillers other than calcium carbonate include graphite, clay, titanium dioxide, magnesium dioxide, aluminum oxide, starch, boron nitride, silicon nitride, aluminum nitride, calcium silicate, and silicon carbide.

The covering layer 23 has a relative dielectric constant of 7 or less. The relative dielectric constant is preferably from 2 to 5. When the covering layer 23 is formed of rubber, a relative dielectric constant of the rubber ranges from 860 MHz to 960 MHz at ambient temperature. Here, the ambient temperature is 23±2° C. and 60%±5% RH (relative humidity) in accordance with the standard conditions of the JIS system. The relative dielectric constant of the rubber is measured according to an electrostatic capacitance method after a 24-hour treatment at 23° C. and 60% RH. The range from 860 MHz to 960 MHz described above corresponds to the allocated frequency of the RFID in the current UHF (ultra-high frequency) band, but in a case where the allocated frequency is changed, it is only required that the relative dielectric constant in the range of the allocated frequency be specified as described above.

In the RFID module described above, the covering layer 23 contains calcium carbonate. This suppresses shrinkage in forming the covering layer 23 compared to a covering layer containing silica, the shape of the RFID module 10 can be kept, and the calcium carbonate as a filler contributes to lowering the relative dielectric constant of the covering layer 23, improving the communication performance of the RFID module 10. Furthermore, the relative dielectric constant of the covering layer 23 being 7 or less can improve the radio wave transmitting property of the RFID module 10, yield the effect of suppressing attenuation of radio wave intensity, and further improve the communication performance of the RFID module 10.

On the other hand, for example, blending silica with the covering layer causes the covering layer to shrink in forming, and fail to keep the desired shape, failing to sufficiently obtain the durability of the covering layer. Further, blending of a non-reinforcing filler other than calcium carbonate in the covering layer may not improve the communication performance of the RFID module due to lack of a component that is effective for reducing the relative dielectric constant.

In the RFID module described above, preferably, the covering layer 23 has a dielectric loss tangent of 0.1 or less, a surface resistivity of 10¹² Ωm or more, and a volume resistivity of 10¹² Ωm or more. The dielectric loss tangent can be set to the range described above to prevent attenuation of radio wave intensity in the RFID module 10 during radio wave transmission, and the electrical resistances can be set to the ranges described above to effectively improve the communication performance of the RFID module 10.

The storage modulus E′c (20° C.) at 20° C. of the covering layer 23 preferably ranges from 2 MPa to 12 MPa. Setting the physical properties of the covering layer 23 as described above can improve the protective effect of the covering layer 23 on the RFID module 10 and effectively improve the durability of the RFID module 10.

The glass transition temperature of the covering layer 23 preferably ranges from −70° C. to −45° C., and more preferably ranges from −60° C. to −45° C. Accordingly, the RFID module 10 can be used even in a high or low temperature environment without its durability being impaired. Here, in a case where the glass transition temperature of the covering layer 23 is lower than the lower limit value, the heat resistance of the covering layer 23 degrades, and the protective effect of the covering layer 23 in a high-temperature environment cannot be sufficiently obtained. Conversely, in a case where the glass transition temperature of the covering layer 23 exceeds the upper limit value, the durability of the covering layer 23 in a low temperature environment degrades, and cracking is likely to occur in the covering layer 23.

The covering layer 23 is preferably formed of rubber or elastomer and 20 phr or more of calcium carbonate. Configuring the covering layer 23 as described above can relatively lower the relative dielectric constant of the covering layer 23 compared to a covering layer containing carbon, effectively improving the communication performance of the RFID module 10. The higher the content of the calcium carbonate, the lower the relative dielectric constant can be. In a case where the covering layer 23 contains more than 25 phr and 30 phr or less of calcium carbonate, for example, the relative dielectric constant of the covering layer 23 can be 4 or more and less than 6. Further, in a case where the covering layer 23 contains more than 30 phr and 40 phr or less of calcium carbonate, the relative dielectric constant of the covering layer 23 can be 2 or more and less than 4. Note that in the present Specification, “phr” means parts by weight per 100 parts by weight of a rubber component (elastomer).

The covering layer 23 preferably contains from 20 phr to 55 phr of calcium carbonate. This can relatively lower the relative dielectric constant of the covering layer 23 and effectively improve the communication performance of the RFID module 10. However, the covering layer 23 excessively containing calcium carbonate becomes brittle, its strength decreases, and this is not preferable. Furthermore, the covering layer 23 can optionally include 20 phr or less of silica (white filler) or 5 phr or less of carbon black in addition to calcium carbonate. Using a small amount of a silica or carbon black in combination can lower the relative dielectric constant of the covering layer 23 while ensuring the strength of the covering layer 23.

Additionally, the thickness of the covering layer 23 is preferably from 0.5 mm or more and 3.0 mm or less, and more preferably 1.0 mm or more and 2.5 mm or less. Here, a thickness t of the covering layer 23 is a rubber thickness at a position including the transponder 20, and is, as illustrated in FIG. 1B, for example, a rubber thickness obtained by summing a thickness t1 and a thickness t2 on a straight line extending through the center of the transponder 20. Appropriately setting the thickness t of the covering layer 23 as described above allows the communication performance of the RFID module 10 to be effectively improved while ensuring the protective effect of the covering layer 23. Here, in a case where the thickness t of the covering layer 23 is less than 0.5 mm, the insulating properties of the covering layer 23 will decrease, and the effect of improving the communication performance of the RFID module 10 cannot be sufficiently obtained. Conversely, in a case where the thickness t of the covering layer 23 exceeds 3.0 mm, the RFID module 10 may be damaged when embedded in a tire. Note that the cross-sectional shape of the covering layer 23 is not particularly limited and that for example, a triangular shape, a rectangular shape, a trapezoidal shape, and a spindle shape can be adopted. The covering layer 23 in FIG. 1B has a cross-section having a rectangular shape.

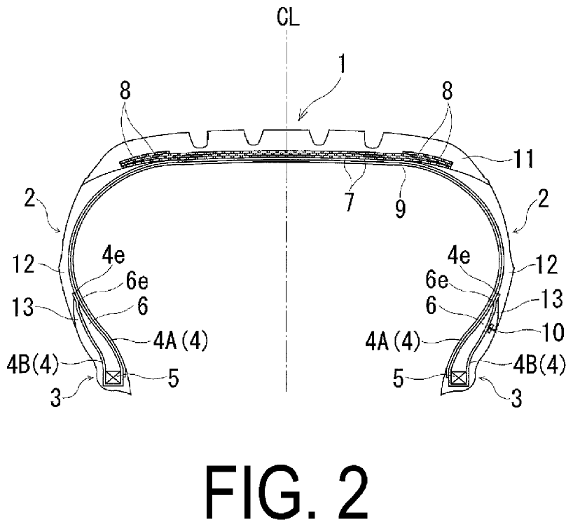

FIGS. 2 to 5 illustrate a pneumatic tire according to an embodiment of the present technology. As illustrated in FIG. 2, a pneumatic tire according to the present embodiment includes a tread portion 1 extending in a tire circumferential direction and having an annular shape, a pair of sidewall portions 2 disposed on two sides of the tread portion 1, and a pair of bead portions 3 disposed in an inner side in a tire radial direction of the pair of sidewall portions 2.

At least one carcass layer 4 (one layer in FIG. 2) formed by arranging a plurality of carcass cords in a radial direction is mounted between the pair of bead portions 3. The carcass layer 4 is covered with rubber. Organic fiber cords of nylon, polyester, or the like are preferably used as the carcass cords forming the carcass layer 4. A bead core 5 having an annular shape is embedded in each of the bead portions 3, and a bead filler 6 made of a rubber composition and having a triangular cross-section is disposed on a periphery of the bead core 5.

On the other hand, a plurality of belt layers 7 (two layers in FIG. 2) is embedded in a tire outer circumferential side of the carcass layer 4 of the tread portion 1. The belt layers 7 includes a plurality of reinforcing cords inclined with respect to the tire circumferential direction, and the reinforcing cords are disposed between the layers intersecting with each other. In the belt layers 7, the inclination angle of each of the reinforcing cords with respect to the tire circumferential direction is set to a range of, for example, 10° to 40°. Steel cords are preferably used as the reinforcing cords of the belt layers 7.

To improve high-speed durability, at least one belt cover layer 8 (two layers in FIG. 2) formed by arranging reinforcing cords at an angle of, for example, 5° or less with respect to the tire circumferential direction is disposed on a tire outer circumferential side of the belt layers 7. In FIG. 2, the belt cover layer 8 located on an inner side in the tire radial direction forms a full cover that covers the entire width of the belt layers 7, and the belt cover layer 8 located on an outer side in the tire radial direction forms an edge cover layer that covers only end portions of the belt layers 7. Organic fiber cords of nylon, aramid, or the like are preferably used as the reinforcing cords of the belt cover layer 8.

In the pneumatic tire described above, both ends 4e of the carcass layer 4 are each folded back from an inner side to an outer side of the tire around the bead core 5 and are disposed wrapping around the bead core 5 and the bead filler 6. The carcass layer 4 includes a body portion 4A corresponding to a portion ranging from the tread portion 1 through each of the sidewall portions 2 to a corresponding one of the bead portions 3 and a turned up portion 4B corresponding to a portion turned up around the bead core 5 at each of the bead portions 3 and extending toward a side of each of the sidewall portions 2.

Additionally, a tire inner surface includes an innerliner layer 9 along the carcass layer 4. The tread portion 1 includes a cap tread rubber layer 11, the sidewall portion 2 includes a sidewall rubber layer 12, and the bead portion 3 includes a rim cushion rubber layer 13.

The RFID module 10 is embedded in the pneumatic tire thus configured. In FIG. 2, the RFID module 10 is disposed in a portion on an outer side in the tire width direction of the carcass layer 4. The transponder 20 forming the RFID module 10 extends along the tire circumferential direction. The transponder 20 may be disposed inclined at an angle ranging from −10° to 10° with respect to the tire circumferential direction.

The pneumatic tire described above, in which the RFID module 10 is embedded, can improve the durability and communication performance of the RFID module 10 while keeping the shape of the covering layer 23. Further, the RFID module 10 is embedded in the outer side in the tire width direction of the carcass layer 4, and no tire component that blocks radio waves during communication of the RFID module 10 is provided, allowing the communication performance of the RFID module 10 to be ensured. In a case where the RFID module 10 is embedded in the outer side in the tire width direction of the carcass layer 4, the RFID module 10 can be disposed between the turned up portion 4B of the carcass layer 4 and the rim cushion rubber layer 13, or between the carcass layer 4 and the sidewall rubber layer 12. As another structure, the RFID module 10 can be disposed between the turned up portion 4B of the carcass layer 4 and the bead filler 6 or between the main body portion 4A of the carcass layer 4 and the bead filler 6.

In the pneumatic tire described above, the antenna 22 preferably has a helical shape, as illustrated in FIG. 1A. The antenna 22 having such a shape can follow deformation of the tire during traveling, thus improving the durability of the RFID module 10.

Also, the relative dielectric constant of the covering layer 23 is preferably lower than the relative dielectric constants of the rubber members disposed adjacent to the covering layer 23 (the coating rubber of the carcass layer 4 and the rim cushion rubber layer 13 in FIG. 2). Setting the relative dielectric constant of the covering layer 23 as described above allows the radio wave transmitting property of the RFID module 10 to be sufficiently ensured.

Further, of rubber members located on an outer side in the tire width direction of the RFID module 10 (the sidewall rubber layer 12 and the rim cushion rubber layer 13 in FIG. 2), a rubber member having the largest storage modulus E′out (20° C.) at 20° C. (hereinafter sometimes referred to as an outer member) corresponds to the rim cushion rubber layer 13, and the storage modulus E′c (20° C.) at 20° C. of the covering layer 23 and the storage modulus E′out (20° C.) at 20° C. of the rubber member having the largest storage modulus at 20° C. of the rubber members located on the outer side in the tire width direction of the RFID module 10 preferably satisfy the relationship 0.1≤E′c (20° C.)/E′out (20° C.)≤1.5, and more preferably satisfy the relationship 0.15≤E′c (20° C.)/E′out (20° C.)≤1.30. The difference in rigidity between the covering layer 23 and the rubber members located on the outer side of the RFID module 10 is not too large, and thus the rigidity of the covering layer 23 with respect to the rubber members can be maintained appropriately. This can improve the durability of the RFID module 10.

Here, in a case where the value of E′c (20° C.)/E′out (20° C.) is smaller than the lower limit value, the rigidity of the covering layer 23 is lower than that of the outer member, and the protective effect of the covering layer 23 on the RFID module 10 decreases. Conversely, in a case where the value of E′c (20° C.)/E′out (20° C.) exceeds the upper limit value, the rigidity of the covering layer 23 is higher than that of the outer member. This makes the covering layer 23 brittle and prone to break, leading to a failure of the RFID module 10.

The storage modulus E′c (20° C.) at 20° C. of the covering layer 23 and the storage modulus E′c (60° C.) at 60° C. of the covering layer 23 preferably satisfy the relationship 1.0≤E′c (20° C.)/E′c (60° C.)≤1.5. Setting the physical properties of the covering layer 23 as described above lowers the temperature dependence of the covering layer 23 (the covering layer 23 is less likely to heat up) and does not soften the covering layer 23 when the temperature of the tire rises during high-speed traveling, allowing the durability of the RFID module 10 to be effectively improved.

The storage modulus E′c (60° C.) at 60° C. of the covering layer 23 and the storage modulus E′a (60° C.) at 60° C. of a rubber member adjacent on an outer side in the tire width direction of the covering layer 23 (the rim cushion rubber layer 13 in FIG. 2) preferably satisfy the relationship 0.2≤E′c (60° C.)/E′a (60° C.)≤1.2. Setting the physical properties of the covering layer 23 and the rubber member adjacent to the covering layer 23 as described above brings the physical properties of both closer, obtaining the effect of dispersing stress during traveling and allowing the durability of the RFID module 10 to be effectively improved.

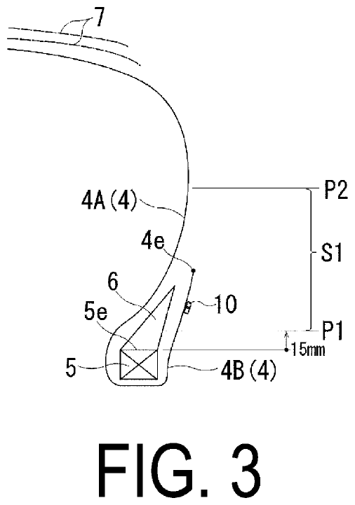

In the pneumatic tire described above, the RFID module 10 is preferably disposed in an arrangement region in the tire radial direction between a position P1, which is 15 mm on an outer side in the tire radial direction of an upper end 5e of the bead core 5 (an end portion on an outer side in the tire radial direction), and a position P2 where the tire width is largest. That is, the RFID module 10 is preferably disposed in a region 51 illustrated in FIG. 3. When the RFID module 10 disposed in the region 51, the RFID module 10 is positioned in a region where the stress amplitude during traveling is small. This can effectively improve the durability of the RFID module 10 but further does not lower the durability of the tire. Here, the RFID module 10 disposed on an inner side in the tire radial direction of the position P1 is brought closer to a metal member such as the bead core 5. This tends to degrade the communication performance of the RFID module 10. On the other hand, the RFID module 10 disposed on an outer side in the tire radial direction of the position P2 is positioned in a region where the stress amplitude during traveling is large, and the damage of the transponder 20 itself and interfacial failure around the RFID module 10 are likely to occur, and this is not preferable.

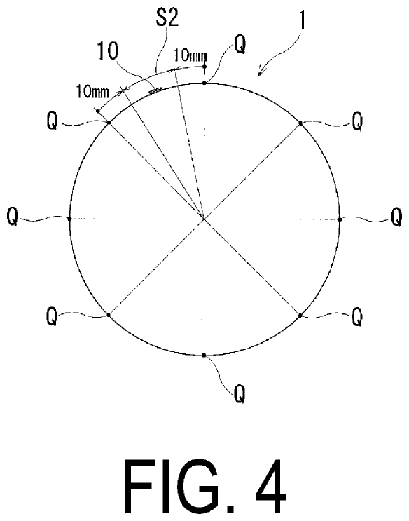

As illustrated in FIG. 4, a plurality of splice portions is on a tire circumference, the plurality of splice portions each being formed by overlaying end portions of a tire component. FIG. 4 illustrates positions Q of the splice portions in the tire circumferential direction. The center of the RFID module 10 is preferably disposed 10 mm or more spaced in the tire circumferential direction from the splice portion of the tire component. That is, the RFID module 10 may be disposed in a region S2 illustrated in FIG. 4. Specifically, the IC substrate 21 forming the RFID module 10 is preferably located 10 mm or more spaced in the tire circumferential direction from the position Q. Furthermore, all of the RFID module 10 including the antenna 22 is more preferably located 10 mm or more spaced in the tire circumferential direction from the position Q, and all of the RFID module 10 covered with a covering rubber is most preferably located 10 mm or more spaced in the tire circumferential direction from the position Q. The tire component disposed spaced from the RFID module 10 is preferably the sidewall rubber layer 12, the rim cushion rubber layer 13, or the carcass layer 4, which is disposed adjacent to the RFID module 10. Disposing the RFID module 10 spaced from the splice portion of the tire component as described above allows tire durability to be effectively improved.

Note that while the embodiment of FIG. 4 illustrates an example in which the positions Q in the tire circumferential direction of the splice portions of the tire components are disposed at equal intervals, no such limitation is intended. The positions Q in the tire circumferential direction can be set anywhere, and in any case, the RFID module 10 is disposed 10 mm or more spaced in the tire circumferential direction from the splice portion of the tire component.

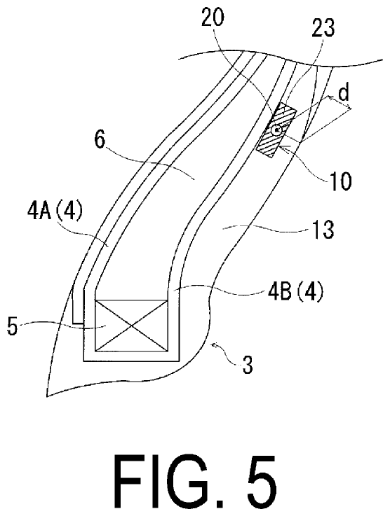

As illustrated in FIG. 5, a distance d between the cross-sectional center of the RFID module 10 and the tire surface is preferably 1 mm or more. Spacing the RFID module 10 from the tire surface allows the tire durability to be effectively improved and the tire scratch resistance to be improved. In the embodiment of FIG. 5, the distanced is the distance between the cross-sectional center of the RFID module 10 and an outer tire surface, but in a case where the RFID module 10 is positioned at a location close to the inner liner layer 9, the distance d is the distance between the center of the cross-sectional center of the RFID module 10 and the tire inner surface.

While the embodiment described above illustrates an example in which the end 4e of the turned-up portion 4B of the carcass layer 4 is disposed at or near an upper end 6e of the bead filler 6, no such limitation is intended, and the end 4e of the turned-up portion 4B of the carcass layer 4 can be disposed at any height. For example, the end 4e of the turned-up portion 4B of the carcass layer 4 may be disposed on a side of the bead core 5. In such a low turn-up structure, the transponder 20 may be disposed between the bead filler 6 and the sidewall rubber layer 12 or the rim cushion rubber layer 13. In such a case, the rubber member adjacent on the outer side in the tire width direction of the covering layer 23 is the sidewall rubber layer 12 or the rim cushion rubber layer 13.

### Example

The RFID modules according to Comparative Examples 1 to 3 and Examples 1 to 8 were manufactured. The RFID modules each include an IC substrate for storing data, an antenna for transmitting and receiving data, and a covering layer covering the antenna. The presence of calcium carbonate in the covering layer, the presence of silica in the covering layer, the presence of a non-reinforcing filler in the covering layer, the relative dielectric constant of the covering layer, the content of calcium carbonate in the covering layer, the thickness of the covering layer, and the storage modulus E′c (20° C.) of the covering layer were set as in Table 1.

Comparative Example 1 used a covering layer containing silica. Comparative Example 2 used a covering layer containing silica and a non-reinforcing filler other than calcium carbonate. Comparative Example 3 used a covering layer containing a non-reinforcing filler other than calcium carbonate.

These RFID modules were evaluated for shape retention, durability, and communication performance according to a test method described below, and the results are shown together in Table 1.

Shape Retention:

The change in dimension after vulcanization molding was measured for each RFID module. The evaluation result is indicated as “Yes” in a case where there was a dimension change greater than ±1 mm compared to before vulcanization and “No” in a case where there was a dimension change in the range of ±1 mm compared to before vulcanization.

Durability:

A constant strain fatigue test was conducted in which each RFID module was subjected to 3 million cycles of repeated deformation at a temperature of from 30° C. to 40° C., a tensile speed of 400±20 rpm, and a constant strain of 80%, and then each RFID module was checked for an appearance failure. The evaluation result is indicated in three levels: “Excellent” in a case where there was no appearance failure; “Good” in a case where there was an appearance failure that did not start with the transponder covered with the covering layer; and “Fair” in a case where there was an appearance failure that started with the transponder covered with the covering layer.

Communication Performance:

For each RFID module, a communication operation was performed using a reader/writer. Specifically, the maximum communication distance was measured with the reader-writer set at a power output of 250 mW and a carrier frequency of from 860 MHz to 960 MHz. Evaluation results are expressed as index values with Comparative Example 1 being assigned an index value of 100. Larger index values indicate superior communication performance.

TABLE 1

| | Comparative | Comparative | Comparative |
|---|---|---|---|
| | Example 1 | Example 2 | Example 3 |
| Presence of calcium carbonate in | No | No | No |
| covering layer | | | |
| Presence of silica in covering layer | Yes | Yes | No |
| Presence of non-reinforcing filler in | No | Yes | Yes |
| covering layer | | | |
| Relative dielectric constant of | 8 | 10 | 10 |
| covering layer | | | |
| Content of calcium carbonate in | 0 | 0 | 0 |
| covering layer [phr] | | | |
| Thickness of covering layer [mm] | 0.2 | 0.2 | 0.2 |
| Storage modulus E′c (20° C.) of | 1 | 1 | 1 |
| covering layer [MPa] | | | |
| Shape retention (presence of | Yes | No | No |
| dimension change) | | | |
| Durability | Fair | Good | Good |
| Communication performance | 100 | 95 | 95 |

| | Example | Example | Example | Example |
|---|---|---|---|---|
| | 1 | 2 | 3 | 4 |
| Presence of calcium carbonate in | Yes | Yes | Yes | Yes |
| covering layer | | | | |
| Presence of silica in covering layer | No | No | No | No |
| Presence of non-reinforcing filler in | No | No | No | No |
| covering layer | | | | |
| Relative dielectric constant of | 7 | 2.5 | 2 | 7 |
| covering layer | | | | |
| Content of calcium carbonate in | 20 | 40 | 55 | 20 |
| covering layer [phr] | | | | |
| Thickness of covering layer [mm] | 0.2 | 0.2 | 0.2 | 0.5 |
| Storage modulus E′c (20° C.) of | 1 | 1 | 1 | 1 |
| covering layer [MPa] | | | | |
| Shape retention (presence of | No | No | No | No |
| dimension change) | | | | |
| Durability | Good | Good | Good | Excellent |
| Communication performance | 104 | 108 | 110 | 106 |
| | Example | Example | Example | Example |
| | 5 | 6 | 7 | 8 |
| Presence of calcium carbonate in | Yes | Yes | Yes | Yes |
| covering layer | | | | |
| Presence of silica in covering layer | No | No | No | No |
| Presence of non-reinforcing filler in | No | No | No | No |
| covering layer | | | | |
| Relative dielectric constant of | 7 | 7 | 7 | 7 |
| covering layer | | | | |
| Content of calcium carbonate in | 20 | 20 | 20 | 20 |
| covering layer [phr] | | | | |
| Thickness of covering layer [mm] | 1.0 | 3.0 | 1.0 | 1.0 |
| Storage modulus E′c (20° C.) of | 1 | 1 | 2 | 12 |
| covering layer [MPa] | | | | |
| Shape retention (presence of | No | No | No | No |
| dimension change) | | | | |
| Durability | Excellent | Excellent | Excellent | Excellent |
| Communication performance | 108 | 110 | 108 | 108 |

Table 1 here shows that the RFID modules of Examples 1 to 8 had shape retention, durability, and communication performance improved in a well-balanced manner.

On the other hand, Comparative Example 1, which used a covering layer containing silica, had a dimensional change and a deterioration in durability. Comparative Example 2, which used a covering layer containing silica and a non-reinforcing filler other than calcium carbonate, had a deterioration in the communication performance of the RFID module. Comparative Example 3, which used a covering layer containing a non-reinforcing filler other than calcium carbonate, had a deterioration in the communication performance of the RFID module.

1. An RFID (radio frequency identification) module, comprising:
an IC (integrated circuit) substrate configured to store data;
an antenna configured to transmit and receive the data; and
a covering layer configured to cover the antenna;
the covering layer containing calcium carbonate and having a relative dielectric constant of 7 or less.

2. The RFID module according to claim 1, wherein the covering layer is formed of rubber or elastomer and 20 phr or more of calcium carbonate.

3. The RFID module according to claim 2, wherein the covering layer includes 20 phr to 55 phr of calcium carbonate.

4. The RFID module according to claim 1, wherein the covering layer has a thickness ranging from 0.5 mm to 3.0 mm.

5. The RFID module according to claim 1, wherein the covering layer has a dielectric loss tangent of 0.1 or less, a surface resistivity of 10¹² Ωm or more, and a volume resistivity of 10¹² Ωm or more.

6. The RFID module according to claim 1, wherein the covering layer has a storage modulus E′c (20° C.) at 20° C. ranging from 2 MPa to 12 MPa.

7. The RFID module according to claim 1, wherein the covering layer has a glass transition temperature ranging from −70° C. to −45° C.

8. A pneumatic tire in which the RFID module according to claim 1 is embedded, comprising:
a tread portion extending in a tire circumferential direction and having an annular shape;
a pair of sidewall portions disposed on both sides of the tread portion;
a pair of bead portions disposed on inner sides in a tire radial direction of the pair of sidewall portions; and
a carcass layer mounted between the pair of bead portions.

9. The pneumatic tire according to claim 8, wherein a relative dielectric constant of the covering layer is lower than a relative dielectric constant of a rubber member disposed adjacent to the covering layer.

10. The pneumatic tire according to claim 8, wherein the RFID module is disposed on an outer side in a tire width direction of the carcass layer, and a storage modulus E′c (20° C.) at 20° C. of the covering layer and a storage modulus E′out (20° C.) at 20° C. of a rubber member having the largest storage modulus at 20° C. of rubber members located on an outer side in the tire width direction of the RFID module satisfy the relationship 0.1≤E′c (20° C.)/E′out (20° C.)≤1.5.

11. The pneumatic tire according to claim 8, wherein a center of the RFID module is disposed 10 mm or more spaced from a splice portion of a tire component in the tire circumferential direction.

12. The pneumatic tire according to claim 8, wherein the RFID module is disposed between a position on an outer side in the tire radial direction by 15 mm of an upper end of a bead core of a bead portion of the pair of bead portions and a tire maximum width position.

13. The pneumatic tire according to claim 8, wherein a distance between a cross-sectional center of the RFID module and a tire surface is 1 mm or more.

14. The pneumatic tire according to claim 8, wherein the antenna has a helical shape.
